(19) United States
(12) Patent Application Publication
(10) Pub. No.: US 2012/0190520 A1
(43) Pub. Date: Jul. 26, 2012

(54) Beverage Pod Packaging Manufacturing Machine

(76) Inventor: Adrian Rivera, Whittier, CA (US)

(21) Appl. No.: 13/011,899

(22) Filed: Jan. 22, 2011

(51) Int. Cl. B31B 1/14

(52) U.S. Cl. 493/56

(57) ABSTRACT

A filter paper cup manufacturing machine produces filter paper cups packaging suitable for containing a brewing material. The filter paper cup packaging has similar depth and diameter. The machine exercises ordered steps of first cutting a receptacle portion and cover portion for each individual packaging and then forming a recess in the receptacle portion for receiving the brewing material. Performing the cutting step first facilitates forming the recess because surrounding filter paper which would resist forming the recess has been eliminated.

### BACKGROUND OF THE INVENTION

The present invention relates to coffee brewing and in particular to efficiently manufacturing a filter paper cup.

Various methods of brewing coffee are known. A popular method is using a single serving pod or filter paper cup in a brewing machine designed to accept the corresponding pod or filter paper cup. Pods are generally disk like with a diameter much greater than the depth of the pod, where as a filter paper cup may have similar diameter and depth. Machines are know for efficiently manufacturing pods and described in U.S. Pat. No. 5,012,629 issued May 7, 1991, U.S. Pat. No. 5,649,412 issued Jul. 22, 1997, and U.S. Pat. No. 7,377,089 issued May 27, 2008. While these patents disclose useful methods to manufacture a typical coffee pod, they reply on methods for forming a brewing material receptacle from strips of flat filter paper material which is only suitable for a shallow receptacle because the filter paper cannot stretch to accommodate forming adjacent pods from a common strip of filter paper. Forming such shallow receptacles require minimum stretching or deformation of the filter paper to form adjacent pods. If these machines are merely scaled for a deeper receptacle, the filter paper would be unacceptably deformed or tear in the process. The '629, 412, and 089 patents are incorporated herein in their entirely by reference.

### BRIEF SUMMARY OF THE INVENTION

The present invention addresses the above and other needs by providing a filter paper cup packaging manufacturing machine which produces filter paper cup packaging for containing a brewing material. The filter paper cup packaging has similar depth and diameter. The machine exercises ordered steps of first cutting a receptacle portion and cover portion for each individual packaging and then forming a recess in the receptacle portion for receiving the brewing material. Performing the cutting step first facilitates forming the recess because surrounding filter paper which would resist forming the recess has been eliminated.

In accordance with another aspect of the invention, there is provided a filter paper cup manufacturing machine comprising a number of sequentially arranged stations. The stations include a roll of first filter paper and a roller guiding the filter paper onto the belt; a cutting station used to perform a circular cut in the filter paper for forming each individual filter paper cup; a stamping station pressing a center portion of the cut filter paper into a corresponding recess in the belt to form a paper recess; a filling station to fill the paper recess in the filter paper with brewing material; a tamping station to tamp the brewing material residing in the paper recess; a vacuum station to remove excess brewing material from a rim of the receptacle portion; a roll of second filter paper and a second roller guiding the second filter paper over the receptacle portion; a seal station bonds the second filter paper to the receptacle portion; and a second cutting station cuts through the second filter paper to compete the filter paper cup.

In accordance with another aspect of the invention, there is provided a method for manufacturing filter paper cups. The method includes the steps of: cutting a separate receptacle portion for forming each individual filter paper cup, forming the receptacle portion; heating or dampening the formed receptacle portion to retain shape; filling the receptacle portion with brewing material; tamping the brewing material; vacuuming excess brewing material; fixing a cover portion over the receptacle portion; and cutting the completed pod.

In accordance with another aspect of the invention, there is provided method for manufacturing a filter paper cup packaging. The method includes: cutting separate attached receptacle portion and cover portion for forming each individual filter paper cup packaging; forming recesses in the receptacle portions; and heating or dampening the formed receptacle portions to retain shape.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a filter paper cup manufacturing machine according to the present invention.

FIG. 2 shown a cover portion and receptacle portion of a filter paper cup according to the present invention.

FIG. 3 is a plate element according to the present invention of a segmented belt.

FIG. 3A is a cross-sectional view of the plate according to the present invention taken along line 3A-3A of FIG. 3.

FIG. 4 is a vacuum table element of the filter paper cup manufacturing machine according to the present invention.

FIG. 5 is a cross-sectional view of the vacuum table element of the filter paper cup manufacturing machine according to the present invention taken along line 5-5 of FIG. 4.

FIG. 6 is a method according to the present invention.

FIG. 7 shows a turret type filter paper cup manufacturing machine according to the present invention.

FIG. 8 shows a turret having arms of the turret type filter paper cup manufacturing machine according to the present invention.

FIG. 9 shows a turret having a rotating table of the turret type filter paper cup manufacturing machine according to the present invention.

FIG. 10 shows a filter paper cup packaging manufacturing machine according to the present invention.

FIG. 11A shows a perspective view of an empty filter paper cup packaging according to the present invention.

FIG. 11B shows a side view of the empty filter paper cup packaging according to the present invention.

FIG. 12 is a method for manufacturing a filter paper cup packaging according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

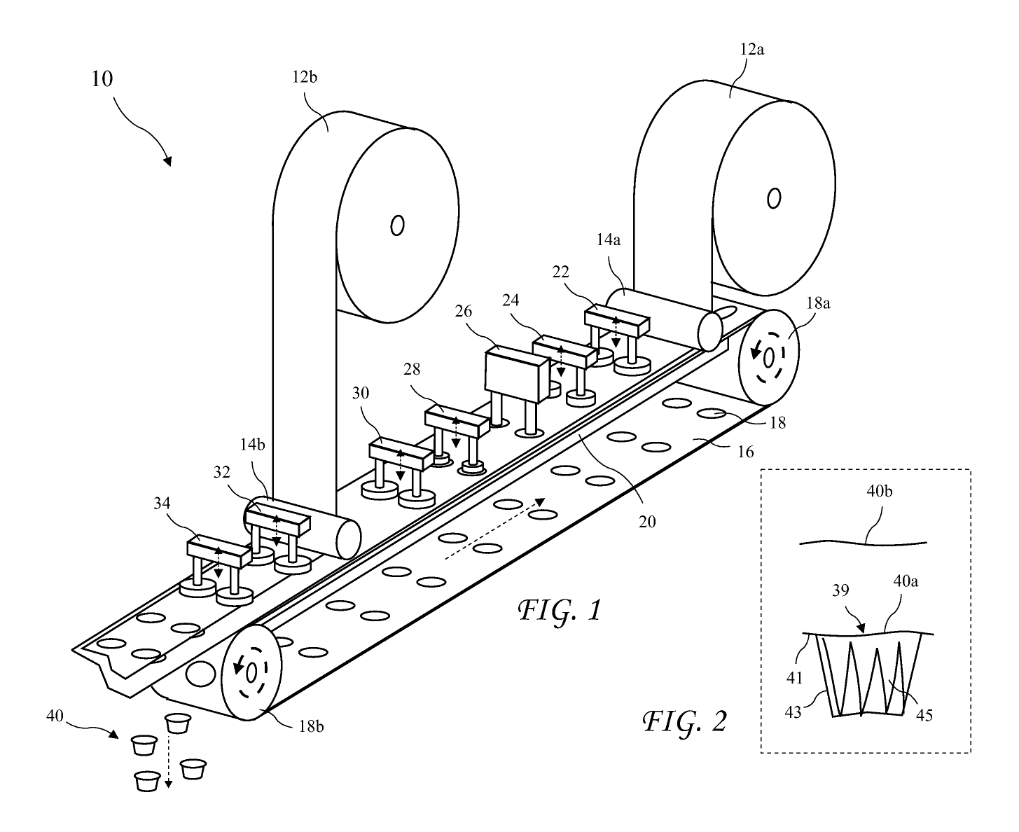

A filter paper cup manufacturing machine 10 according to the present invention is shown in FIG. 1. The filter paper cup manufacturing machine 10 includes a belt 16 running around two rollers 18a and 18b. The belt 16 includes belt recesses 18 used for forming and holding filter paper cup receptacle portions during the manufacturing of filter paper cups 40. A vacuum table 20 resides under the higher path of the belt 16 to hold first filter paper material 12a and the lower portions 40b (see FIG. 2) as they are formed and filled with brewing material.

A series of ordered stations process filter paper to manufacture the completed filter paper cups 40. The stations comprise: a roll of first filter paper 12a and a roller 14a guiding the filter paper 12a onto the belt 16; a cutting station 22 used to perform a circular cut in the filter paper 12a to create separate pieces of filter paper for forming each individual filter paper cup; a stamping station 24 pressing a center portion of the cut filter paper into a corresponding recess 18 in the belt 16 to form a paper recess 39 and using heat or dampening to retain the shape of the recess 39; a filling station 26 to fill the paper recess 39 in the filter paper 12a with brewing material; a tamping station 28 to tamp the brewing material residing in the paper recess 39; a vacuum station 30 to remove excess brewing material from a rim 41 of the receptacle portion 40a; a roll of second filter paper 12b and a second roller 14b guiding the second filter paper 12b over the receptacle portion 40a; a seal station 32 bonds the second filter paper to the receptacle portion 40a; and a second cutting station cuts through the second filter paper 12b to compete the filter paper cup 40.

The stations of the filter paper cup manufacturing machine 10 are similar to stations of U.S. Pat. No. 5,649,412 (incorporated by reference above), but significantly, the first station is the cutting station 22 which cuts substantially all of the perimeter of the receptacle portion 40a from the first filter paper 12a and the receptacle portion 40a is held against the belt 16 for subsequent stations by vacuum provided by the vacuum table 20. While it is preferred to cut the receptacle portion 40a entirely away from the first filter paper 12a to allow for forming the recess 39 in the receptacle portion 40a, a small attachment between the receptacle portion 40a and the filter paper 12a to, for example, help control the position of the receptacle portion 40a during processing at subsequent stations.

While the stations 22, 24, 26, 28, 30, 32, and 34 are shown as separate spaced apart stations, the some or all of the stations 22, 24, 26, 28, 30, 32, and 34 may be combined in a single station which performs that processing of the separate stations 22, 24, 26, 28, 30, 32, and 34 in the same order as the spaced apart stations. For example, a single station may include a cutter to first cut the receptacle portion 40a from the filter paper 12a, and then a stamp to form the recess 39 in the receptacle portion 40a. Other stations may be similarly combined. Further, when accepting filter paper from rolls, precut filter paper may be fed and positioned onto the belt 16. Importantly, any filter paper cup manufacturing machine 10 forming a recess 39 in a pre-cut receptacle portion 40b is intended to come within the scope of the present invention.

The receptacle portion 40a and cover portion 40b of the filter paper cups 40 are shown in FIG. 2. The receptacle portion 40a include a rim 41 and recess 39. Forming the recess 39 in the receptacle portion 40a of the filter paper cup 40 preferably includes using heat and/or moisture to form permanent folds (or pleats) 45 in the sides 43 and rim 41 of the receptacle portion 40a to add strength and rigidity to the receptacle portion 40a so that the receptacle portion 40a retains its shape after forming, and preferably, adhesive is present in the filter paper 12a or is applied to the rim 41 and/or the sides 43 to retain the pleats and add strength and rigidity to the filter paper cup 40. Preferably, the receptacle portion 40a is constructed from heat sealable filter paper having a heat reacting film on at least one side, which film causes the pleats to adhere to adjacent pleats when heat is applied following forming. The pleats 45 in the rim 41 are generally continuations of the pleats in the sides 43. The receptacle portion 40a may alternatively be corrugated to retain shape. The receptacle portion 40a thus has structure for maintaining a substantially (i.e., within the ability of the paper to maintain a shape) frusto-conical or cylindrical shape unlike known coffee pods with have no structure for maintaining shape and are pillow-like with diameter much greater than depth. U.S. patent application Ser. No. 11/392,893 filed Mar. 28, 2006 filed by the present inventor, discloses a similar filter paper cup forming a coffee pod. The '893 application is herein incorporated by reference in its entirely.

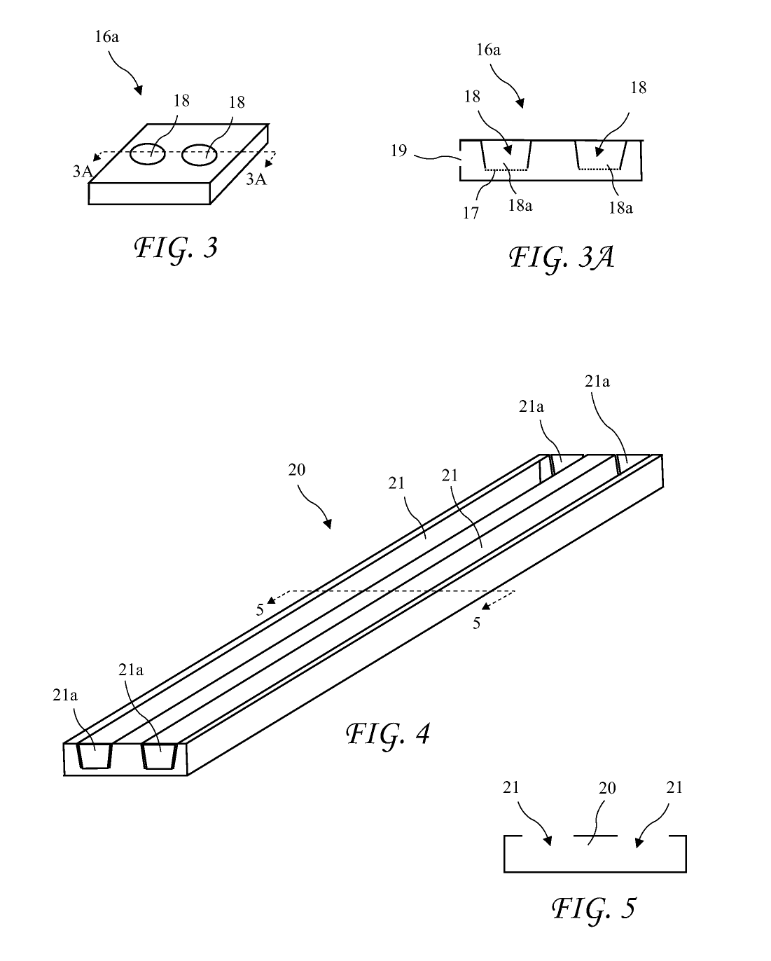

The belt 16 may be a continuous belt or a segmented (e.g. tractor tread like) belt (or continuous chain) configured to receive plates 16a, allowing substitution of plates having various recess 18 sizes. A perspective view of the plate 16a is shown in FIG. 3 and a cross-sectional view of the plate 16a taken along line 3A-3A of FIG. 3 is shown in FIG. 3A. Each plate includes at least one recess 18 for forming and processing one or more receptacle portions 40a. A vacuum source is provided along the edge or bottom of the plates 16a to retain the filter paper on the plates 16a during processing and to remove the vacuum when the filter paper cups 40 are complete. At completion, the vacuum source may be replace by a pressure source to facilitate the finished filter paper cup 40 exit from the recess in the plate. The plates 16a are preferably coated with a low friction material (for example Teflon®).

The plate 16a includes the belt recesses 18 for receiving and shaping the receptacle portion 40a. The plate 16a preferably includes perforations 17 or other means allowing vacuum to communicate with the filter paper 12a for retain the position of the filter paper while forming the receptacle portion 40a, and a vacuum port 19 in communication with a vacuum source. An example of such a segmented belt is discloses in U.S. Pat. No. 5,649,412 incorporated by reference above.

An example of one vacuum source for a continuous belt 16 is the vacuum table 20 according to the present invention shown in FIG. 4 and a cross-sectional view of the vacuum table 20 taken along line 5-5 of FIG. 4 is shown in FIG. 5. The vacuum table includes gaps 21 allowing belt recesses 16 on the bottom of the continuous belt 16 to enter and leave the vacuum table 20. Gates 21a are formed from a flexible or deformable material at each end of the gaps 21 to limit the loss of vacuum during operation of the filter paper cup manufacturing machine 10. The gates 21a bend or deform when the belt recesses 16 enter or exit the vacuum table 20. Other types of gates may be used, for example, brushes reaching upward or inward and a filter paper cup manufacturing machine 10 having a vacuum table including any form of gate to limit the loss of vacuum is intended to come within the scope of the present invention.

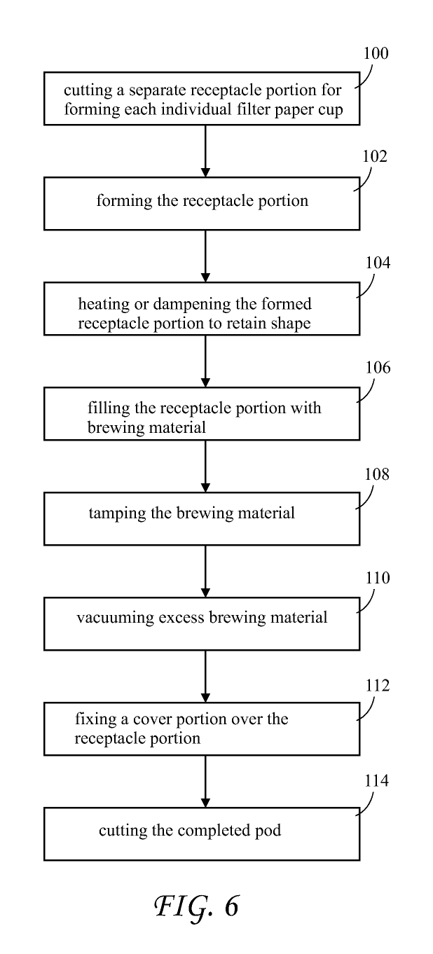

A method according to the present invention is shown in FIG. 6. The method includes the steps of: cutting a separate receptacle portion for forming each individual filter paper cup at step 100, forming the receptacle portion at step 102; heating or dampening the formed receptacle portion to retain shape at step 104; filling the receptacle portion with brewing material at step 106; tamping the brewing material at step 108; vacuuming excess brewing material at step 110; fixing a cover portion over the receptacle portion at step 112; and cutting the completed pod at step 114. The heating or dampening the formed receptacle portion to retain shape at step 104 is preferably heating heat sealable filter paper having a heat reacting film on at least one side to retain shape of the receptacle portion.

A turret type filter paper cup manufacturing machine 50 according to the present invention is shown in FIG. 7. The turret type filter paper cup manufacturing machine 50 includes a rotating center 50 and arms 52 rotating under the stations 22, 24, 26, 28, 30, 32, and 34 of FIG. 1. Each arm 52 may includes a vacuum source to retain the receptacle portion 40a position. After the cutting station 43, the arm may be rotated and the vacuum removed to allow the completed filter paper cup 40 to drop from the arm.

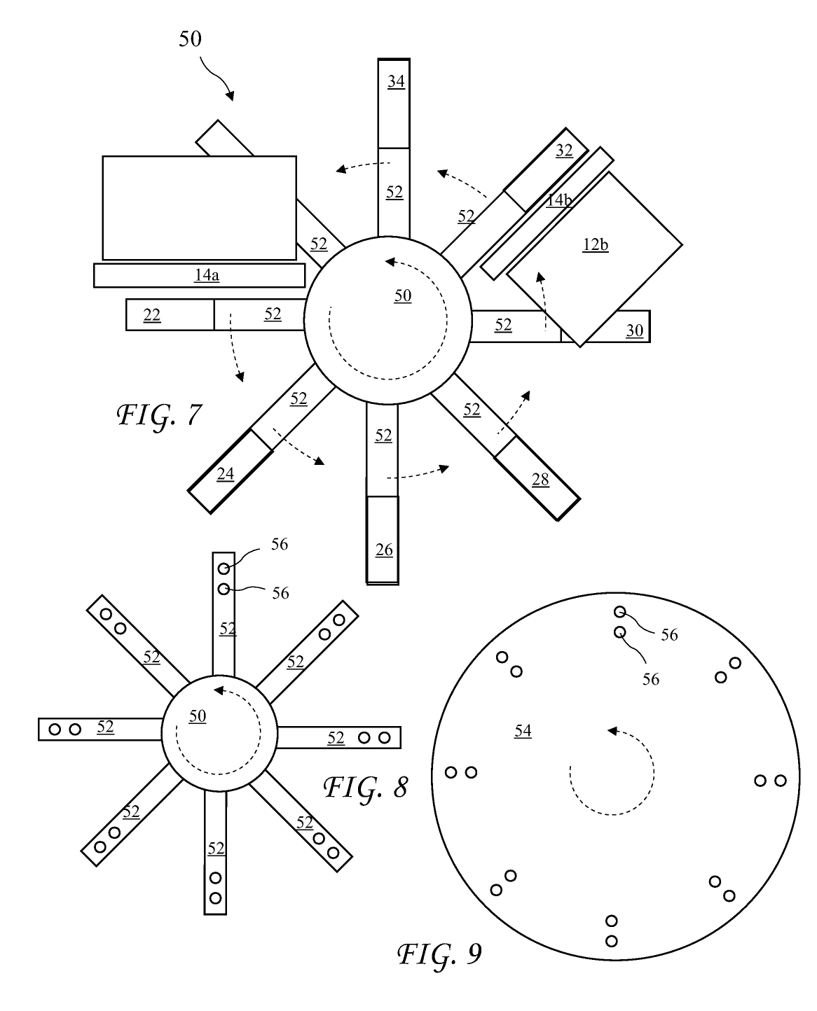

A turret having the arms 52 of the turret type filter paper cup manufacturing machine 50 is shown in FIG. 8 and a turret having a rotating table of the turret type filter paper cup manufacturing machine 50 is shown in FIG. 9. The turret includes receptacles 65 which are rotated under the stations 22-34f for forming the filter paper cups 40. Both the arms 52 and the table 54 may include the vacuum source for holding the filter paper during processing.

In an alternative embodiment, the horizontally turret is replaced by a vertical carrousel. The stations are positioned around the carrousel to process the filter paper to manufacture the filter paper cup. In still another embodiment, the filter paper is held fixed while the stations are moved linearly, in a horizontal circular motion (e.g., like the horizontal turret), or along a vertical arc (e.g., as along a vertical arc). When the filter paper cup is completed, the filter paper is advanced.

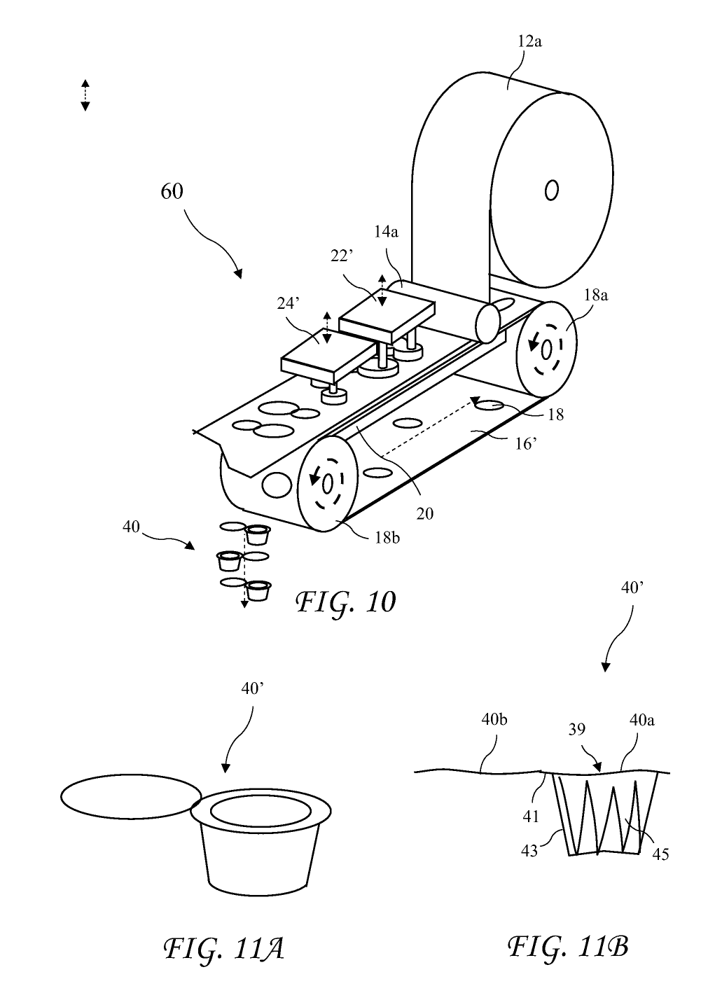

A filter paper cup packaging manufacturing machine 60 according to the present invention is shown in FIG. 10 and a perspective view of an empty filter paper cup packaging 40′ according to the present invention is shown in FIG. 11A and a side view of an empty filter paper cup packaging 40′ according to the present invention is shown in FIG. 11B. The filter paper cup packaging manufacturing machine 60 manufactures empty filter paper cups for use with a brewing material holder as disclosed in U.S. patent application Ser. No. 12,960,496 filed Dec. 4, 2010 by the present inventor. The '496 application is herein incorporated by reference.

The filter paper cup packaging 40′ is preferably made from a single piece of filter paper cut from the filter paper 12a at station 22′ with cuts for two or more filter paper cup packagings 40 in a single operation, and the recesses 39 for two or more filter paper cup packagings 40 in a single operation at station 24′. Because each cut creates a smaller circular cut attached to a larger circular cut, the filter paper cup packagings 40 are alternated in consecutive cuts to optimize the use of the filter paper 12a. Just as in manufacturing the filled filter paper cups 40 described above, significantly, the filter paper is first cut, and then the recesses 39 are formed. If the filter paper 12a was not first cut and then formed, the forming step would tear or otherwise distort the filter paper 12a.

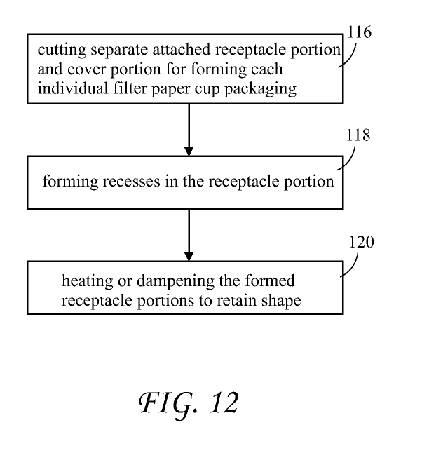

FIG. 12 is a method for manufacturing a filter paper cup packaging according to the present invention. The method includes: cutting separate attached receptacle portion and cover portion for forming each individual filter paper cup packaging at step 116; forming recesses in the receptacle portions at step 118; and heating or dampening the formed receptacle portions to retain shape at step 120. The filter paper is preferably a heat sealable filter paper having a heat reacting film on at least one side to retain shape of the receptacle portion, and the formed recess is heated to retain shape.

While the invention herein disclosed has been described by means of specific embodiments and applications thereof, numerous modifications and variations could be made thereto by those skilled in the art without departing from the scope of the invention set forth in the claims.

I claim:

1. A filter paper cup packaging manufacturing machine comprising:
a roll of filter paper and a roller guiding the filter paper onto a belt;
a cutting station having a blade to cut in the filter paper into a receptacle portion and a cover portion for each individual filter paper cup packaging; and
a stamping station pressing a center portion of the receptacle portion into a corresponding recess in the belt to form a paper recess for receiving a brewing material.

2. The filter paper cup packaging manufacturing machine of claim 1, wherein the receptacle portion and the cover portion are cut as a single piece from the filter paper.

3. The filter paper cup packaging manufacturing machine of claim 2, wherein the receptacle portion is cut larger than the cover portion and after forming has approximately the same diameter and the cover portion.

4. The filter paper cup packaging manufacturing machine of claim 1, wherein the filter paper is heat sealable filter paper having a heat reacting film on at least one side to retain shape of the paper recess and the filter paper cup manufacturing machine includes a heating station for heating the heat sealable filter paper after forming the recess in the receptacle.

5. The filter paper cup packaging manufacturing machine of claim 4, wherein the heating station is part of the stamping station and heats the heat sealable filter after forming a recess in the receptacle portion.

6. The filter paper cup packaging manufacturing machine of claim 1, further including a belt for advancing the filter paper and wherein the stations are spaced apart alone the belt.

7. The filter paper cup packaging manufacturing machine of claim 6, wherein the stations are linearly spaced apart alone the belt.

8. The filter paper cup packaging manufacturing machine of claim 7, wherein the belt is a continuous belt and further including a vacuum table under a under the higher path of the belt and providing vacuum to retain the filter paper position on the belt.

9. The filter paper cup packaging manufacturing machine of claim 6, wherein the belt is a segmented belt and further including plates insertable and removeable from the segmented belt.

10. The filter paper cup packaging manufacturing machine of claim 9, wherein the plates are replaceable with plates having different recess sizes to form different shaped receptacle portions.

11. The filter paper cup packaging manufacturing machine of claim 1, further including a turret having arms cooperating with fixed stations of the filter paper cup manufacturing machine.

12. The filter paper cup packaging manufacturing machine of claim 1, further including a turret having rotating stations attached to arms.

13. A filter paper cup packaging manufacturing machine comprising:
a roll of filter paper and a roller guiding the filter paper onto a belt;
a cutting station having a blade to cut in the filter paper into a receptacle portion and a cover portion cut from a single piece of filter paper for each individual filter paper cup packaging, the receptacle portion is cut larger than the cover portion and after forming has approximately the same diameter and the cover portion; and
a stamping station pressing a center portion of each receptacle portion into a corresponding recess in the belt to form a paper recess in the receptacle portion.

14. A method for manufacturing filter paper cup packaging, the method comprising the steps of:
cutting a receptacle portion and cover portion from filter paper for each individual filter paper cup packaging;
forming a recess in the receptacle portion in the cut filter paper; and
heating the formed filter paper to retain the shape of the recess receptacle portion.

15. The method of claim 14, wherein cutting a receptacle portion and cover portion for each individual filter paper cup packaging comprises cutting the receptacle portion and cover portion for each individual filter paper cup packaging from a single piece of filter paper.

16. The method of claim 15, wherein cutting a receptacle portion and a cover portion for each individual filter paper cup packaging comprises cutting the receptacle portion larger than the cover portion and after forming the recess in the receptacle portion, the formed receptacle portion has approximately the same diameter and the cover portion;

17. The method of claim 14, further including dampening the formed receptacle portion before heating to retain the shape of the recess.

18. The method of claim 14, wherein the filter paper includes a heat reacting film on at least one side, and heating the heat reacting film causes the receptacle portion to retain the shape of the recess in the formed receptacle portion.
